(19) United States
(12) Patent Application Publication
(10) Pub. No.: US 2017/0345113 A1
(43) Pub. Date: Nov. 30, 2017

(54) RIDE TRADING AVAILABILITY USING VEHICLE TELEMATICS

(71) Applicant: GM Global Technology Operations LLC, Detroit, MI (US)

(72) Inventor: Krishnendu KAR, South Lyon, MI (US)

(21) Appl. No.: 15/163,120

(22) Filed: May 24, 2016

(51) Int. Cl. G06Q 50/30; G06Q 30/02; H04W 4/02

(52) U.S. Cl. CPC G06Q 50/30; H04W 4/025; G06Q 30/0261; G06Q 30/0267; H04W 4/021

(57) ABSTRACT

A system and method of communicating vehicle-based service offers between wireless devices includes: receiving, at a central facility, a location from a wireless device used by a potential service consumer; determining, at the central facility, a community from the received location, wherein the community represents a geofenced boundary the location exists within; associating the wireless device with the community in a database at the central facility; receiving at the central facility a service offer and a location or community from a second wireless device used by a vehicle owner; searching the database for the community associated with the second wireless device; determining that the community associated with the second wireless device is also associated with the wireless device in the database; and transmitting the service offer received from the second wireless device to the wireless device.

### TECHNICAL FIELD

The present invention relates to vehicles and, more particularly, to communicating vehicle availability among wireless devices located within a geographic boundary.

### BACKGROUND

Presently, individual vehicle owners use their vehicles as transportation for individual purposes. These individual purposes include commuting to a place of employment, shuttling children to one or more schools, or driving to shopping centers to purchase a variety of retail items. Many times, a large number of people within a small neighborhood repeatedly travel along the same trip for individual purposes, which results in excessive cumulative travel within the neighborhood while vehicles are only partially occupied. While vehicle owners use vehicles for individual or private purposes, those owners may be unaware that other people travel at similar times to similar destinations also in vehicles that are partially occupied. At least some of the time, vehicle owners would benefit from trading rides with others. However, unless the vehicle owner knows through personal interaction that other people want to travel to a common destination and do so at a time that is convenient to the vehicle owner, vehicle sharing or ride trading is unlikely to occur.

### SUMMARY

According to an embodiment of the invention, there is provided a method of communicating vehicle-based service offers between wireless devices. The method includes receiving, at a central facility, a location from a first wireless device used by a potential service consumer; determining, at the central facility, a community from the received location, wherein the community represents a geofenced boundary containing the location; associating the first wireless device with the community in a database at the central facility; receiving at the central facility a service offer and a location or community from a second wireless device used by a vehicle owner; searching the database for the community associated with the second wireless device; determining that the community associated with the second wireless device is also associated with the first wireless device in the database; and transmitting the service offer received from the second wireless device to the first wireless device.

According to another embodiment of the invention, there is provided a method of communicating vehicle-based service offers between wireless devices. The method includes receiving a service offer from a vehicle owner at a wireless device; generating a global positioning system (GPS) location at a first wireless device; transmitting the GPS location along with the service offer from the first wireless device to a central facility; and receiving at the first wireless device from the central facility a service acceptance generated by a second wireless device used by a potential service consumer.

According to yet another embodiment of the invention, there is provided a wireless device that includes a global positioning system (GPS) module configured to receive a plurality of GPS satellite signals and generate GPS coordinates representing the location of the wireless device; one or more antennas configured to wirelessly communicate data via a cellular communications protocol, a short-range wireless protocol, or both; and a processor, in communication with a computer-readable memory, configured to execute computer-readable instructions stored in the computer-readable memory and receive a service offer, generate a GPS location at the wireless device, transmit the GPS location along with the service offer from the wireless device to a central facility, and receive from the central facility a service acceptance generated by a second wireless device used by a potential service consumer.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of communicating vehicle-based service offers between wireless devices.

### DETAILED DESCRIPTION OF THE ILLUSTRATED EMBODIMENT(S)

The system and method described below communicates service offers and acceptance of those offers between wireless devices that are associated with a community defined by a geofenced boundary. Vehicle owners often have planned trips with a beginning point, an end point, and a temporal window during which the planned trip is carried out for a specific service. When vehicle owners have available seats in their vehicle, the owners may want to offer those seats as a service to riders who are willing to travel along on the same trip during the same temporal window. Or when services provided by the vehicle owners matches a service desired in the community and there is space in the vehicle, a vehicle owner can perform the service within the community for a fee. Vehicle owners can offer their planned trip to potential riders in the community who, by virtue of their geographic proximity, may likely have an interest in participating in the planned trip.

Vehicle owners can input the details of one or more service offers into a wireless device and a community related to the vehicle owner can be identified. The service offer can be sent to a central facility along with the vehicle owner's location, the location of the service offer, or both. The central facility can associate the service offer with a particular community based on the existence of at least one of these locations in a particular community. For example, a vehicle owner can input the details of a planned trip into a wireless device, including a beginning/ending location and temporal period. The wireless device can query the owner for the owner's location or determine one using an integral GPS module. The wireless device can then send the planned trip and location to the central facility. The central facility organizes planned trips and/or other service offers by community, therefore the planned trip received from the vehicle owner can be associated with the community in which it will be carried out.

The service offers can be maintained by a database containing a plurality of different communities that are each defined by a unique geofence. For each community, the central facility may manage service offers, such as a plurality of planned trips, and transmit the service offers to wireless devices associated with the community carried by potential consumers of that service who can review the offers and transmit an acceptance to the central facility. For each community, the central facility can store a significant number of planned trips or other service offers along with associated variables, such as fee data or vehicle owner feedback ratings, for each offer. The central facility can then provide a plurality of planned trips or other service offers to wireless devices that are also located in or otherwise associated with the community.

In some implementations, the vehicle owner can request a service fee for performing the service, such as transporting riders along the planned trip, and can specify that fee along with the details of the planned trip. The service fee can be presented along with the service offer to wireless devices carried by individuals in the community who are potential service consumers. The vehicle owners and potential service consumers may each be associated with a user assessment reflecting commentary by others about their performance. This assessment can be compiled into a letter grade or some other assessment that reflects performance relative to other members of the community. These comments, graded assessments, or both can be presented to wireless devices along with the service offer so that potential riders can be more comfortable accepting the service.

The central facility can wirelessly send service offers, such as a seat in a vehicle for a planned trip, to a plurality of wireless devices that are located in, or otherwise have selected to receive service offers associated with a particular community. Potential service consumers who carry those wireless devices can review a plurality of service offers for their community. Planned trips—one example of a service offer—can include variables such as a vehicle owner's location, the starting/ending points of the trip, the temporal window of the trip, a vehicle owner's name, the vehicle owner's graded assessment, the proposed fee for providing the ride, and/or vehicle owner's present availability and accept the planned trips if desired. The potential service consumers can view the planned trips on displays of their wireless devices, compare the planned trips offered by vehicle owners in the community, and determine which planned trip is acceptable.

If a service such as the planned trip is acceptable, then it can be selected via a user interface of the wireless device. The wireless device can then wirelessly transmit this acceptance to the central facility, which can facilitate communications between the vehicle owner offering the service and the user accepting the service. The central facility can wirelessly send the location of a vehicle to the user accepting service and the location of the user to the vehicle owner. In addition, the central facility can support a text-based messaging system that allows the vehicle owner and the user accepting service to communicate.

In addition to planned trips, the vehicle owner can generate other types of service offers using a wireless device. The vehicle owner can offer to purchase groceries or other merchandise within their community and specify a particular fee for doing this. These types of service offers can be generated instead of or in addition to planned trips. While planned trips and merchandise purchases have been explicitly identified as types of service offers generated by a vehicle owner, it should be understood that other types of service offers are possible even though that may not be expressly identified here.

The service provider, such as a vehicle owner, and a service consumer can communicate with each other through a messaging system to carry out or complete a service. The massaging system can also support communications by other members within or associated with a community even if they are not participating in a service using a vehicle at that time but have participated in the past.

### Communications System—

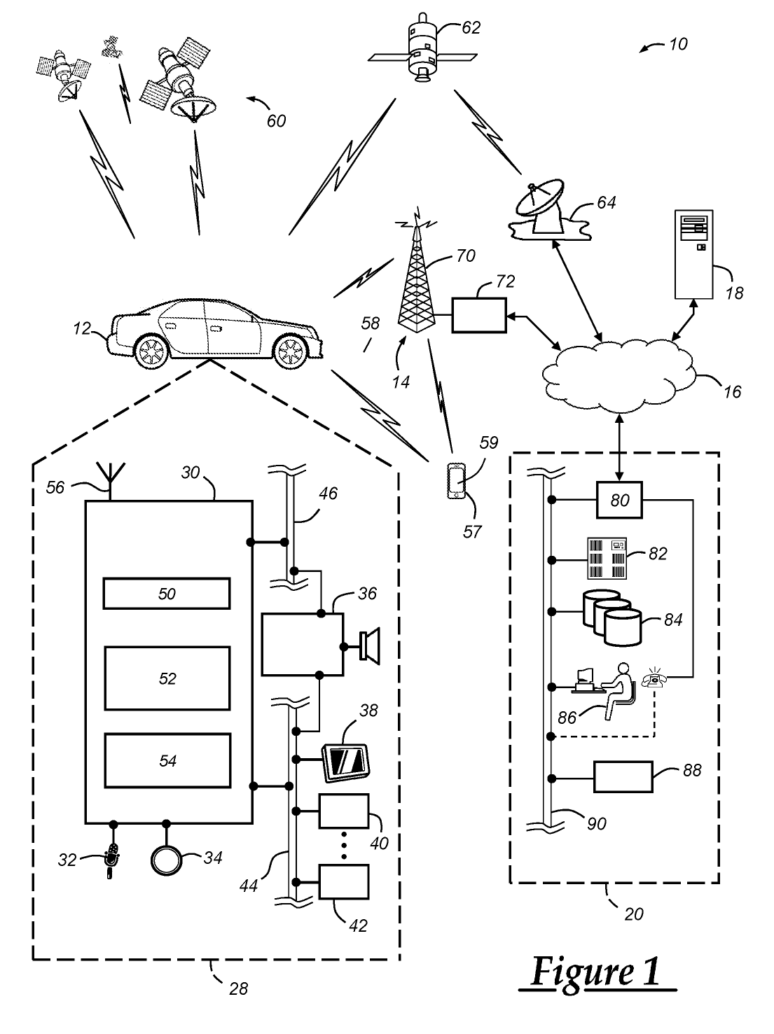

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, bicycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This wireless device enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

One of the networked devices that can communicate with the telematics unit 30 is a wireless device, such as a smart phone 57. The smart phone 57 can include computer processing capability, a transceiver capable of communicating using a short-range wireless protocol, and a visual smart phone display 59. The computer processing capability can include a microprocessor in the form of a programmable device that includes one or more instructions stored in an internal memory structure and applied to received binary input to create binary output. In some implementations, the smart phone 57 include a GPS module capable of receiving GPS satellite signals and generating GPS coordinates based on those signals. And in other implementations, the smart phone 57 includes cellular communications functionality such that the smart phone 57 carries out voice and/or data communications over the wireless carrier system 14 using one or more cellular communications protocols, as are discussed herein. The visual smart phone display 59 also includes a touch-screen graphical user interface. Examples of the smart phone 57 include the iPhone™ manufactured by Apple, Inc. and the Galaxy™ manufactured by Samsung, Inc., as well as others. While the smart phone 57 may include the ability to communicate via cellular communications using the wireless carrier system 14, this is not always the case. For instance, Apple manufactures devices such as the various models of the iPad™ and iPod Touch™ that include the processing capability, the display 59, and the ability to communicate over a short-range wireless communication link. However, the iPod Touch™ and some iPads™ may not have cellular communication capabilities. Even so, these and other similar devices may be used or considered a type of wireless device, such as the smart phone 57, for the purposes of the method described herein.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1×EV-DO) or GSM/GPRS (e.g., 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30 or a third party repository to or from which vehicle data or other information is provided, whether by communicating with the vehicle 12, the call center 20, the smart phone 57, or some combination of these. The computer 18 can maintain a searchable database and database management system that permits entry, removal, and modification of data as well as the receipt of requests to locate data within the database. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

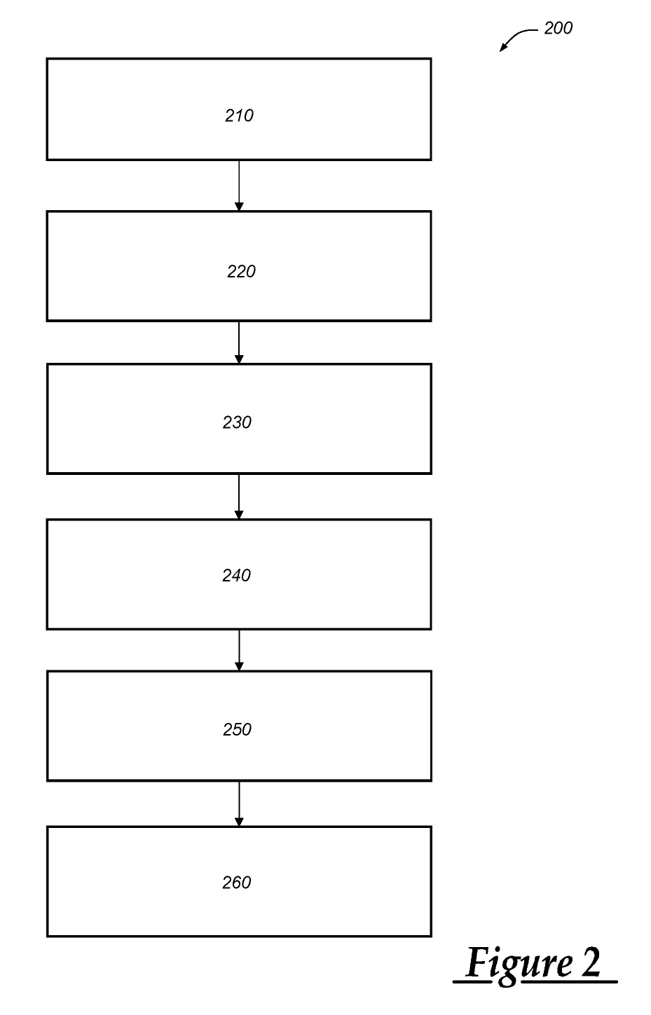

Turning now to FIG. 2, there is shown an implementation of a method (200) of communicating vehicle-based service offers between wireless devices. The wireless devices in this implementation of the method 200 will be described in terms of the vehicle telematics unit 30 and the smart phone 57 while the central facility will be described based on the computer 18. However, it should be apparent that other implementations are possible with different wireless devices and other central facilities. For example, the method 200 could use two smart phones, two vehicle telematics units, a tablet and a vehicle telematics unit, or some other combination appreciated by those skilled in the art. And the method 200 could use the call center 20 rather than the computer 18 as the central facility. These and other configurations are within the scope of this disclosure.

The method 200 begins at step 210 by receiving, at the computer 18, a location from a smart phone 57 used by a potential service consumer. The potential service consumer can register with the computer 18 using a consumer identifier and a location. The consumer identifier can be a unique handle that distinguishes the potential service consumer from other consumers. The computer 18 can maintain a profile of the potential service consumer using the consumer identifier. For example, the profile can include a default location, such as a residence or place of employment, payment information in the form of a credit card number, and contact information. The contact information may be a mobile dialed number (MDN) of the smart phone 57, email addresses, or a billing address. The smart phone 57 can receive the location as well as other data using an application program interface (API) stored at the phone that defines graphically-displayed input domains as well as rules for accepting input and generating output.

The potential service consumer can enter a location into the smart phone display 59 and the smart phone 57 can wirelessly transmit the location to the computer 18. The location can be defined by the potential service consumer using an address, zip code, an area code, the name of a city, township, or other similar governmental boundary. For purposes of this description, governmental boundary refers to a geographical boundary that is defined not by individuals but rather a governmental body having at least some legal authority within that geographical boundary. The location can also be defined by a road or an intersection of roads. In some implementations, the smart phone 57 obtains the location using a GPS module integrated with the phone in the form of GPS coordinates. The method 200 proceeds to step 220.

At step 220, the computer 18 determines a community from the received location. The community can represent a geofenced boundary that follows a geographical boundary indicated by the location or can be drawn to incorporate a plurality of locations. Geofences can refer to geographical boundaries that are created using a plurality of latitude/longitude coordinates and are generally known to those skilled in the art. The computer 18 can identify the latitude/longitude coordinates of the location, identify one or more communities having geofences the location lies within, and then associate the community or communities with that potential service consumer. For example, a potential service consumer can input the name of a city for a location and the community can be defined by the computer 18 as the boundary of that city in the form of a geofence. In another example, the potential service consumer can input an intersection of two roads as a location and the computer 18 can then associate the location of those two roads within a community. These roads may lie on a boundary between two governmental boundaries as could occur at the border of two cities and a community can be created that includes portions of each governmental boundary within a geofence. Even though two cities have a sharp boundary between them, the geofences for each community can be drawn such that they partially overlap at the sharp boundary. It is possible to include a potential service consumer in more than one community if communities have been defined such that they overlap. The method 220 proceeds to step 230.

At step 230, the community is associated with the smart phone 57 or potential service consumer in a database at the computer 18. The computer 18 can associate the community with a potential service consumer/smart phone 57 using the profile of that consumer. The potential service consumer can maintain the profile and provide data to the database that is associated with the profile. The community associated with that profile is linked with other profiles of potential service consumers who also have specified a common community. The profiles can then be identified and searched in the database based on community. The method 200 proceeds to step 240.

At step 240, a service offer and a location or community is received at the computer 18 from the vehicle telematics unit 30 used by a vehicle owner. The vehicle owner can be a person who has legal title to the vehicle 12 or a person who is otherwise authorized to use the vehicle 12. The vehicle owner can provide a service offer to the vehicle telematics unit 30 via the microphone 32 or the display 38. The vehicle owner can also input an owner identifier along with the service request or the vehicle telematics unit 30 can maintain the owner identifier in a memory device at the vehicle 12 and automatically append it to the service offer provided to the computer 18. The owner identifier can be a unique handle that identifies the vehicle owner to the computer 18 and database. As noted above the service offer can be a planned trip having a beginning point, and ending point, and a temporal period. For example, the vehicle owner may regularly drive a child to school from their residence within a community. The vehicle owner can enter the location of the residence (beginning point), the location of the school (ending point), and the temporal period between when the vehicle owner begins driving to school and a planned arrival time. The residence and the school can be identified by address or dropping a pin on a map presented on the display 38. The vehicle owner may also specify a fee that he expects for the service offer. The vehicle owner may specify a fee of $5 for transporting a person along the planned ride. And this fee can be modified based on how far a potential service consumer is from the beginning point. In one example, the fee can be $5 if the potential service consumer is located within a mile of the vehicle owner and $7 if greater than one mile away. The service offer—along with fee data and a vehicle owner identifier—can then be wirelessly communicated to the computer 18.

While the service offer is described in terms of a planned trip, vehicle owners can present other types of service offers. The vehicle owner may travel in their vehicle 12 to a number of merchants, such as grocery stores, restaurants, or gas stations. These trips can form the basis for a service offer. In another example, the vehicle owner may travel to the grocery store every Saturday morning. The vehicle owner can then generate a service offer for a grocery store trip on Saturday with a beginning point at their residence and an ending point at the grocery store having a temporal period beginning somewhere between 8-11:30 AM and ending an hour later.

In some implementations, the vehicle owner can also provide a location to the computer 18 indicating the location of the vehicle 12 and/or the vehicle owner. The vehicle telematics unit 30 can generate GPS coordinates using the GPS module 40 and wirelessly transmit the coordinates to the computer 18. The vehicle telematics unit 30 can then periodically update the location of the vehicle 12. Alternatively, the vehicle owner can enter an address or other point of interest indicating a present location or a place the vehicle owner plans to be along with a time at which he will be there. The computer 18 can receive the location and store it with a profile belonging to the vehicle owner.

A profile can be maintained in the database belonging to the vehicle owner that associates a variety of information with the vehicle owner. The vehicle owner's profile can include the owner's name, a vehicle identifier, a vehicle location, one or more service offers, a fee for performing each service offer, and/or a status indicating whether the vehicle owner is presently available. The vehicle identifier may be a vehicle identification number (VIN) or other indicator that provides the year, make, model, and other distinguishing characteristics of the vehicle. The vehicle 12 can periodically send data via a wireless signal to the computer 18 updating the vehicle location and status. Status can refer to whether the vehicle owner is presently available. This can be an signal indicating whether or not the vehicle ignition is on or off or whether a wireless device belonging to the vehicle owner is currently connected to the vehicle telematics unit 30 via short-range wireless protocol. The profile can also include information used to contact the vehicle owner, such as a mobile dialed number (MDN) of the vehicle telematics unit 30 or of a wireless device the vehicle owner uses. The MDN may be used to communicate information between the vehicle owner and a potential service consumer. The method 200 proceeds to step 250.

At step 250, the database is searched for the community associated with the vehicle telematics unit 30. After receiving a service offer from the vehicle owner, the computer 18 determines an appropriate community to associate the offer with. Continuing the planned school trip example discussed above, the computer 18 can read the address of the beginning point (the residence) and/or the ending point (the school) and identify the community based on the city included in the address(es). Or the computer 18 can use the vehicle location or the location specified by the vehicle owner to establish the appropriate community. The location or address can be provided in latitude and longitude coordinates and then communities in the database can be compared to the location. The computer 18 identifies one or more communities related to the service request and then associates the community or communities with the vehicle owner, service request, and/or vehicle telematics unit 30 in the database. The method 200 proceeds to step 260.

At step 260, the service offer received from the vehicle telematics unit 30 is transmitted to a plurality of wireless devices used by potential service consumers that are associated with a particular community. The database includes service offers from one or more vehicle owners grouped according to community. Potential service consumers who carry wireless devices, such as smart phone 57, and have been associated with a particular community can request offers associated with that community from the computer 18. The computer 18 can access the database and obtain all of the service offers for the community. Those service offers can then be wirelessly sent from the computer 18 to smart phone 57 as well as any other wireless device in the community or specifying the community. The smart phone 57 can specify the community via a GPS location generated by the phone or the user can manually enter a location.

The smart phone 57 receives the service offers wirelessly sent from the computer 18 and presents them via the smart phone display 59. The potential service consumer can view the service offers in the community and, if one or more of the offers are wanted, select the offers using the smart phone display 59. The smart phone 57 accepts the selection and can wirelessly transmit a message to the computer 18 identifying the smart phone 57, the consumer of the service, the service offer, or some combination of these three. The computer 18 then contacts the vehicle owner via the telematics unit 30 to alert the owner that a service offer has been selected. Communications between the vehicle telematics unit 30 and the smart phone 57 can be supported by the computer 18. The vehicle telematics unit 30 and the smart phone 57 can communicate text messages through the computer 18, which can also provide location the location of the vehicle 12 to the smart phone 57 and the location of the smart phone 57 to the vehicle telematics unit 30.

Upon conclusion of the service, the computer 18 can debit the service consumers credit card or other payment mechanism the agreed-upon fee. In some implementations, the computer 18 may also charge a service fee for performing all or parts of method 200. The vehicle owner and service consumer may then be offered the chance to give feedback about the consumer of the service and the service itself, respectively. This feedback can be associated with the vehicle owner and service consumer in their profiles stored in the database at the computer 18. When subsequent service offers appear with a vehicle owner, potential service consumers can review feedback belonging to the vehicle owner. Similarly, the vehicle owner can review feedback belonging to the potential service consumer before carrying out a service. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of communicating vehicle-based service offers between wireless devices, comprising the steps of:
(a) receiving, at a central facility, a location from a first wireless device used by a potential service consumer;
(b) determining, at the central facility, a community from the received location, wherein the community represents a geofenced boundary containing the location;
(c) associating the first wireless device with the community in a database at the central facility;
(d) receiving at the central facility a service offer and a location or community from a second wireless device used by a vehicle owner;
(e) searching the database for the community associated with the second wireless device;
(f) determining that the community associated with the second wireless device is also associated with the first wireless device in the database; and
(g) transmitting the service offer received from the second wireless device to the first wireless device.

2. The method of claim 1, wherein the community is determined at the central facility from an address included in the service offer.

3. The method of claim 1, further comprising the step of receiving a fee value with the service offer.

4. The method of claim 1, wherein the community comprises a plurality of geofenced boundaries that partially overlap each other, wherein the first wireless device, the second wireless device, or both are located in one of the geofenced boundaries.

5. The method of claim 1, wherein the first wireless device or the second wireless device further comprises a cellular chipset for communicating via a wireless carrier system.

6. The method of claim 1, wherein the first wireless device comprises a smart phone.

7. The method of claim 1, wherein the second wireless device comprises a smart phone.

8. The method of claim 1, wherein the second wireless device comprises a vehicle telematics unit.

9. A method of communicating vehicle-based service offers between wireless devices, comprising the steps of:
(a) receiving a service offer from a vehicle owner at a first wireless device;
(b) generating a global positioning system (GPS) location at the wireless device;
(c) transmitting the GPS location along with the service offer from the first wireless device to a central facility; and
(d) receiving at the first wireless device from the central facility a service acceptance generated by a second wireless device used by a potential service consumer.

10. The method of claim 9, further comprising the step of receiving a fee value with the service offer.

11. The method of claim 9, further comprising the step of identifying a community based on the transmitted GPS location.

12. The method of claim 11, wherein the community comprises a plurality of geofenced boundaries that partially overlap each other, wherein the first wireless device, the second wireless device, or both are located in one of the geofenced boundaries.

13. The method of claim 9, wherein the first wireless device or the second wireless device further comprises a cellular chipset for communicating via a wireless carrier system.

14. The method of claim 9, wherein the first wireless device comprises a smart phone.

15. The method of claim 9, wherein the second wireless device comprises a smart phone.

16. The method of claim 9, wherein the first wireless device comprises a vehicle telematics unit.

17. A wireless device, comprising:
a global positioning system (GPS) module configured to receive a plurality of GPS satellite signals and generate GPS coordinates representing the location of the wireless device;
one or more antennas configured to wirelessly communicate data via a cellular communications protocol, a short-range wireless protocol, or both; and
a processor, in communication with a computer-readable memory, configured to execute computer-readable instructions stored in the computer-readable memory and receive a service offer, generate a GPS location at the wireless device, transmit the GPS location along with the service offer from the wireless device to a central facility, and receive from the central facility a service acceptance generated by a second wireless device used by a potential service consumer.

18. The wireless device of claim 17, wherein the wireless device comprises a vehicle telematics unit.

19. The wireless device of claim 17, wherein the wireless device comprises a smart phone.

20. The wireless device of claim 17, further comprising a cellular chipset for communicating via a wireless carrier system.
